(19) United States
(12) Patent Application Publication
(10) Pub. No.: US 2017/0101816 A1
(43) Pub. Date: Apr. 13, 2017

(54) Remote Window Opening Device

(71) Applicant: Paul Michael Kozonasky, Concord, CA (US)

(72) Inventor: Paul Michael Kozonasky, Concord, CA (US)

(21) Appl. No.: 15/291,928

(22) Filed: Oct. 12, 2016

Related U.S. Application Data
(60) Provisional application No. 62/240,162, filed on Oct. 12, 2015.

(51) Int. Cl. E05F 15/77; E05F 15/643; E05F 15/635

(52) U.S. Cl. CPC E05F 15/77; E05F 15/635; E05F 15/643; E05F 2700/00; E05Y 2201/434; E05Y 2201/71; E05Y 2201/668; E05Y 2201/656; E05Y 2400/85; E05Y 2400/30; E05Y 2400/40; E05Y 2900/148

(57) ABSTRACT

A device for opening and closing a sliding window via a motorized drive mechanism, which can be controlled remotely. A drive assembly with a motor-controlled drive wheel is mounted on a window sill, and the drive wheel selectively engages with a track attached to the window glass. Signals are sent from a remote device to actuate the motor, turning the drive selectively engaged with the track to slide the window open and closed.

### CROSS REFERENCE TO RELATED APPLICATIONS

This Application claims priority under 35 U.S.C. §119(e) from earlier filed U.S. Provisional Application Ser. No. 62/240,162, filed Oct. 12, 2015. The entirety of the above-listed provisional application is incorporated herein by reference.

### BACKGROUND

### Technical Field

The present device is in the field of powered window-opening devices, especially those which can be remotely operated.

### Background

Opening and closing windows regulates the ambient temperature in an enclosed space by controlling the air flow. Therefore, one may want to open or close a window to change the temperature or when a desired temperature is reached. However, at times one may not be close enough to a window to reach over and slide it open or closed. Further, a person may have difficulty getting over to a window due to disability or being inconveniently disposed, such as in bed.

Although remotely controlled window systems do exist, the control mechanisms and devices are integrated into the system. These are usually seen in larger buildings or specialized high-end construction projects, but not in residential or common commercial properties. Therefore, a remote window operating system would need to be retrofitted to a window, which can be very costly, requiring professional installation.

What is needed is a convenient and easily installed device to open and close a sliding window from a remote location.

### SUMMARY

The present device provides a mechanized system to remotely open and close a sliding window. A user, via a remote device, can operate a microcontroller unit that controls a motor. A motor can connect to a drive wheel that can selectively engage with a strip or “track” affixed to a window surface. As the wheel turns, a window can move in a linear path to open and close. Magnetic sensors can be mounted to a motor control housing to detect magnets at the terminal ends of a strip on a window surface to stop the motor when a window is fully opened or closed.

### BRIEF DESCRIPTION OF THE DRAWINGS

Further details of the present device are explained with the help of the attached drawings in which:

FIG. 1 depicts a perspective view of an embodiment of the present device installed on a window.

FIG. 2a depicts a detail view of a drive assembly embodiment of the present device.

FIG. 2b depicts a detail view of a motor mount assembly embodiment of the present device.

FIG. 2c depicts a perspective view of an embodiment of a mounting bracket in the present device.

FIG. 3 depicts a planar view of an embodiment of the present device during installation.

### DETAILED DESCRIPTION

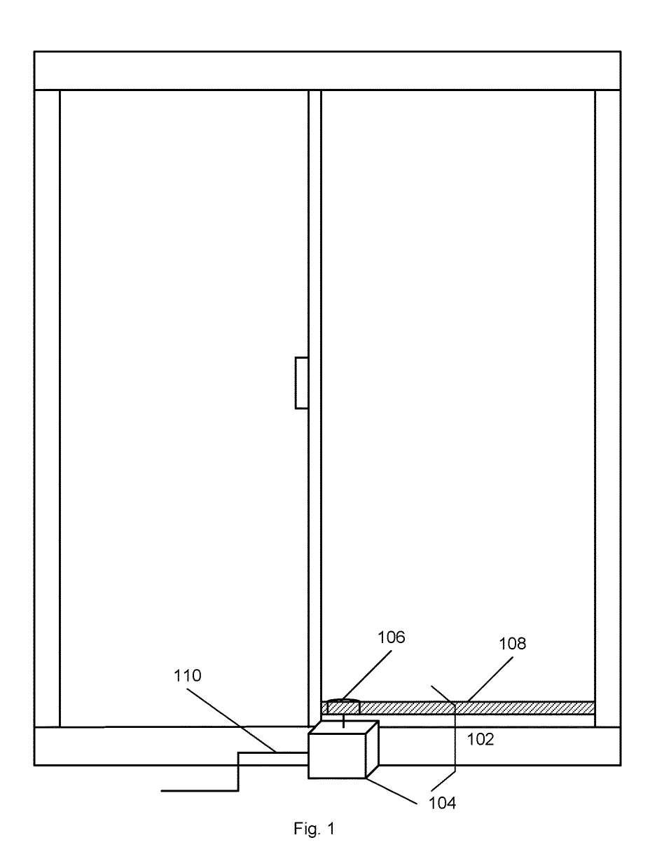

FIG. 1 depicts an embodiment of the present device installed on a window. As shown, a drive assembly 102 can have a motor control housing 104 encasing internal drive control components, while a drive wheel 106 can be located exterior to a motor control housing 104. In the embodiment shown in FIG. 1, a motor control housing 104 can have a substantially rectangular geometry, with substantially flat and substantially orthogonal surfaces, but in other embodiments can have any other known and/or convenient configuration. A motor control housing 104 can be comprised of a polymer, metal, wood, or any other known and/or convenient material.

As shown in FIG. 1, a drive wheel 106 can be oriented above and, with its central axis substantially perpendicular to, the top surface of a motor control housing 104. In some embodiments, a drive wheel 106 can have a longitudinal circumferential surface that can have a width substantially equal to that of a drive wheel 106 at its central axis. However, in other embodiments, a drive wheel 106 can have a tapered or any other known and/or convenient geometry. A drive wheel 106 can be comprised of a polymer, metal, wood, or any other known and/or convenient material or combination of these materials.

As shown in FIG. 1, an elongated member 108 can be a strip or track segment, but in other embodiments can have any other known and/or convenient configuration. An elongated member 108 can be comprised of a flexible or rigid material, such as, but not limited to a polymer. In some embodiments, an elongated member 108 can be substantially transparent to not interfere with sight out of a window, but in other embodiments can be translucent or opaque. In some embodiments, an elongated member 108 can have a first substantially planar surface and a second substantially planar surface. A first surface can have adhesive properties conducive to removably or permanently affixing to a glass surface or any other known and/or convenient surface. At least a portion of the longitudinal circumferential surface of a drive wheel 106 can selectively engage with a second substantially planar surface of an elongated member 108 via friction contact, selectively compatible textured surfaces, or any other known and/or convenient method. In other embodiments, the longitudinal circumferential surface of a drive wheel 106 can have raised protrusions to selectively engage with corresponding recesses on second substantially planar surface of an elongated member 108, or vice-versa.

In the embodiment shown in FIG. 1, the present device can have an exterior power source connection 110 that can be plugged into a wall socket or an extension cord from such. In other embodiments, the present device can have an internal power supply, such as batteries instead of or in addition to an exterior power source connection 110.

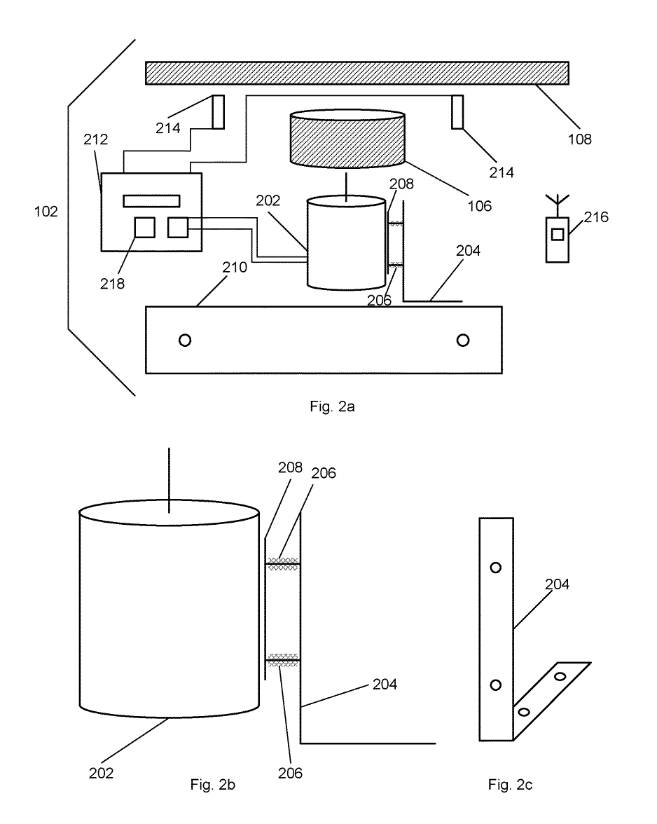

In the embodiment shown in FIG. 2a, a drive assembly 102 can have some components located inside of a motor control housing 104. A motor 202 can be connected to a bracket 204 via at least one spring mount mechanism 206 and a motor attachment plate 208. In such embodiments, a bracket 204, spring mount mechanism 206, and motor attachment plate 208 can be comprised of metal, polymer, or any other known and/or convenient material or combination of such materials.

A drive assembly mounting bracket 210 can have a top surface and a bottom surface. In some embodiments, a drive assembly bracket 210 can have an L-shaped cross-section, but in other embodiments can have any other known and/or convenient geometry. A bracket 204 can connect to the top surface of a drive assembly mounting bracket 210 with threaded connectors, rivets, adhesive, or any other known and/or convenient connecting devices.

As shown in FIG. 2a, a microcontroller unit 212 can electrically connect to a motor 202. In some embodiments, a microcontroller unit 212 can also electrically connect to at least one magnetic sensor 214. A microcontroller unit 212 can be configured to accept input from a remote device 216 to a receiver 218 via wireless, Bluetooth, hard-wired or any other known and/or convenient method, and a receiver 218 can be integrated with or electrically connected to a microcontroller unit 212. In some embodiments, a microcontroller unit 212 can be configured to accept preset values as well as manual remote operation corresponding to desired duration and direction of motor 202 rotation output.

FIG. 2b depicts a detail view of a motor 202, mounting bracket 204, spring mount mechanisms 206, and motor mounting plate 208. A spring mount mechanism 206 can comprise a helical coil, elastomeric component, or any other known and/or convenient device. A motor mounting plate 208 can be connected to a motor mounting bracket 204 via threaded connectors, adhesive, friction-fit connectors, or any other known and/or convenient device. A mounting bracket 204 and a motor mounting plate 208 can be comprised of metal, polymer, or any other known and/or convenient material. In some embodiments, a mounting bracket 204, spring mount mechanisms 206, and motor mounting plate 208 can be fabricated to allow position adjustment relative to each other. FIG. 2c depicts a perspective view of a mounting bracket 204.

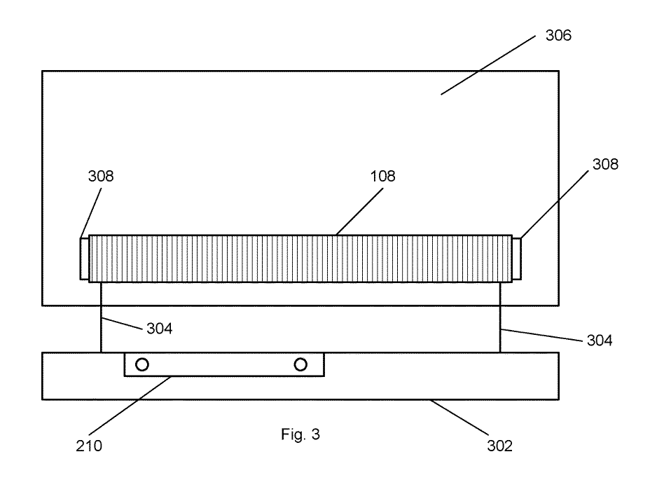

FIG. 3 depicts an embodiment of mounting hardware for the present device. In FIG. 3, a drive assembly 102, which can include a motor control housing 104, which can be removed from a drive assembly mounting bracket 210 to facilitate installment. A drive assembly mounting bracket 210 can be attached to a window sill 302 via threaded connectors, such as, but not limited to screws, adhesive, or any other known and/or convenient device. In some embodiments, at least one removable height alignment guide 304, can be attached to a longitudinal edge of an elongated member 108 to indicate the proper height to place an elongated member 108 on window glass 306.

In some embodiments, at least one magnetic component 308 can be affixed to an elongated member 108. At least one magnetic sensor 214 can be configured to detect a magnetic component 308, which can provide an input to a microcontroller unit 212 to correspond to desired duration and direction of motor 202 rotation output; for example, stopping a motor 202 when a window has reached the limits of its sliding range. At least one magnetic sensor 214 can be positioned externally to a motor control housing 104 and substantially horizontally aligned with a drive wheel 106 to detect when a magnetic component 308 is in position indicating a desired sliding range limit.

In use, an elongated member 108 can be affixed to a window 306 using at least one removable height alignment guide 304. As shown in the embodiment of FIG. 3, a user can position an elongated member 108 next to window glass 306 by placing the distal ends of removable height alignment guides 304 in contact with and substantially perpendicular to the top surface of a window sill 302. This can provide the proper placement of an elongated member 108 on window glass 306. A user can then affix an elongated strip 108 in this location on window glass 306 via adhesive or any other known and/or convenient method. After an elongated strip 108 is securely affixed to window glass 306, a user can remove height alignment guides 304 by snapping, cutting, or any other known and/or convenient method.

A user can affix a drive assembly 102 to a window sill 302 via a drive assembly mounting bracket 210. In some embodiments, a drive assembly 102 can be mounted such that the bottom surface of a motor control housing 104 can be substantially flush with the top surface of a window sill 302 and substantially flush against the window frame. In this position, a drive wheel 106 can be substantially horizontally aligned with an elongated member 108 to selectively engage. In some embodiments, a spring mount mechanism 206 can allow for fine adjustments. A mounting bracket 204 and a motor mounting plate 208 can also allow for adjustments. When a drive wheel 106 selectively engages with an elongated member 108, the present device can be ready for actuation.

To actuate the present device, a remote device 216 can transmit input signals to a receiver 218, which can be connected to a microcontroller unit 212. A microcontroller unit 212 can process input signals to direct a motor 202 to rotate forward or reverse, which can rotate a drive wheel 106 accordingly. In some embodiments the drive shaft of a motor 202 can connect directly to a drive wheel 106, but in other embodiments, a drive train system, such as, but not limited to gears, chain drives, and pulley drives, can intervene to produce a different rotation speed and/or direction in a drive wheel 106. A drive wheel 106 can selectively engage with an elongated member 108. As a drive wheel 106 rotates, engagement with an elongated member 108 can result in a linear movement of a window in a direction to open or close it.

In some embodiments, magnets 308 can be placed at the terminal points of an elongated member 108. When magnetic sensors 214 detect magnets 308, they can signal a microcontroller unit 212 to stop a motor 202. Also, in some embodiments, a bar-code or any other known and/or convenient sensing device can be used to pre-set desired window positions.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the claims.

What is claimed:

1. A window-opening device comprising:
a substantially planar elongated member having a first substantially planar surface having adhesive properties and a second substantially planar surface and a pair of longitudinal edges;
a drive wheel having a longitudinal circumferential surface,
wherein said longitudinal circumferential surface and second substantially planar surface of an elongated member selectively engage;
a drive assembly,
wherein a motor is connected to a drive wheel positioned externally to a motor control housing,
a microcontroller unit electrically connected to a receiver,
a remote device that transmits signals to said receiver,
a motor connected to said microcontroller unit,
wherein said motor is connected to a bracket via a motor attachment plate and a spring-mounted device, and said bracket is connected to a drive assembly mounting bracket,
a motor control housing, and an external power source connection.

2. The device of claim 1, further comprising,
at least one magnetic sensor electrically connected to said microcontroller unit,
and at least one magnet affixed to an elongated member.

3. The device of claim 2, further comprising,
at least one removable height alignment guide extending substantially perpendicularly from a longitudinal edge of said elongated member.

4. The device of claim 3, wherein said longitudinal circumferential surface of said drive wheel further comprises a plurality of raised regions.

5. The device of claim 4, wherein said second substantially planar surface further comprises a plurality of raised regions compatible with the plurality of raised regions on said drive wheel.

6. The device of claim 5, wherein a microcontroller unit is programmable for preset values.

7. The device of claim 1, further comprising a drive train connecting said motor and said drive wheel.

8. A window-opening device, comprising:
a substantially planar elongated member having a first substantially planar surface having adhesive properties and a second substantially planar surface having a plurality of ridges running substantially perpendicular to the longitudinal axis of said elongated member and a pair of longitudinal edges;
a drive wheel having a circumferential edge,
wherein said circumferential edge has a series of ridges substantially parallel to the central axis of said drive wheel;
a drive assembly,
wherein a motor is connected to said drive wheel such that said drive wheel is positioned outside of a motor control housing and said motor is inside said motor control housing,
a microcontroller unit electrically connected to said motor;
a receiver electrically connected to said microcontroller unit;
a remote device connected to said receiver;
wherein said motor is connected to a motor attachment plate, which is connected to a bracket via a spring-mounted device, and said bracket is connected to a drive assembly mounting bracket;
and an external power source connection.

9. The device of claim 8, further comprising,
a pair of magnetic sensor electrically connected to said microcontroller unit,
and a pair of magnets affixed to each terminal end of an elongated member.

10. The device of claim 9, further comprising,
a pair of removable height alignment guides extending substantially perpendicularly from a longitudinal edge of said elongated member.

11. The device of claim 10, wherein a microcontroller unit is programmable for preset values.

12. The device of claim 11, wherein said remote device is connected to said receiver wirelessly.

13. The device of claim 12, further comprising a drive train connecting said motor and said drive wheel.

14. The device of claim 13, wherein said drive train comprises a set of meshed gears.

15. The device of claim 13, wherein said drive train comprises a chain drive mechanism.

16. The device of claim 13, wherein said drive train comprises a pulley drive mechanism.

17. A window-opening device, comprising:
a substantially planar elongated member having a first substantially planar surface having adhesive properties and a second substantially planar surface and a pair of substantially parallel longitudinal edges;
a drive wheel having a longitudinal circumferential surface,
wherein said longitudinal circumferential surface has a plurality of substantially regularly spaced ridges substantially parallel to the longitudinal axis of said drive wheel;
wherein said second substantially planar surface has a plurality of substantially regularly spaced ridges substantially regularly spaced and substantially perpendicular to said edges of said substantially planar elongated member;
wherein said second substantially planar surface of an elongated member selectively engages with said drive wheel;
a drive assembly,
wherein a motor is connected to a drive wheel located externally to a motor control housing;
a microcontroller unit electrically connected to said motor;
a receiver electrically connected to said microcontroller;
a remote device that transmits signals to said receiver wirelessly;
wherein said motor is connected to a bracket via a motor attachment plate and a spring-mounted device, and said bracket is connected to a drive assembly mounting bracket,
a motor control housing,
and an external power source connection.
